(19) United States
(12) Patent Application Publication
(10) Pub. No.: US 2007/0288680 A1
(43) Pub. Date: Dec. 13, 2007

(54) Device and connection control method

(75) Inventors: Masashi Tominaga, Kanagawa (JP); Tadashi Jomura, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 11/806,960

(22) Filed: Jun. 5, 2007

(30) Foreign Application Priority Data
Jun. 8, 2006 (JP) 2006-159242
Apr. 12, 2007 (JP) 2007-104430

(51) Int. Cl. G06F 13/20

(52) U.S. Cl. 710/313

(57) ABSTRACT

In a device connected wirelessly with a host, a host identification information holding unit holds identification information of the host. A connection control unit of the device searches for an identification signal including the host identification information transmitted from the host, where the search is for connecting with the host at a predetermined time interval until the search is succeeded. The host may be a wireless USB (WUSB: Wireless Universal Serial Bus) host. In such case, the connection control unit performs a search for a MMC (Micro-scheduled Management Command) from the wireless USB host.

### BACKGROUND OF THE INVENTION

1. Field of the Invention

The present invention relates to connecting with a host, and particularly to a technique for connecting from a device to a host, where the device is connected wirelessly with the host.

2. Description of the Related Art

Wired USB (Universal Serial Bus) is becoming to be a standard interface of a personal computer (hereinafter simply referred to as a PC) and the standard has been updated along with the advance of functions including higher speed of data transmission. The latest standard 2.0 at the moment achieves 480 Mbps.

The specification of wireless USB (hereinafter referred to as WUSB) that has complete compatibility with USB 2.0 standard and its usability that is of no difference to USB 2.0 realizes high-speed transmission of 480 Mbps even by wireless. Further, the specification is to be able to accomplish transmission speed of 1 Gb in the future by expanding a bandwidth of a frequency to be used. Thus the specification is expected to attract lots of attention as an interface for PC. With this, it is expected that not only wireless connection between PC and peripheral device but also wireless connection between digital household electric appliances such as digital television and digital camera be rapidly used in practice.

Connection mode for a WUSB network is hub and spoke model, where devices are connected to a host (for example PC) that is located at the center. Communications between the host and device are point-to-point, in which connections are made one-to-one. The devices are for example printer, hard disk, digital camera, game console and PDA. Devices having dual (double) role function are also included. For example when connecting a digital camera with a PC, which is a host, the digital camera is a device. However when connecting the digital camera to a printer for outputting, the digital camera may function as a host in a limited way and the printer may function as a device.

In a WUSB cluster (hereinafter simply referred as a cluster) constituted of a host and devices connected according to the WUSB standard, the host manages cluster (including devices in the cluster) using MMC (Micro-Scheduled Management Command). MMC includes host identification information and device control information or the like.

In a WUSB system, the host takes charges in communications between host and devices in a cluster. The host starts a communication with the devices by issuing a token packet to the devices.

On the other hand, as for connections, device-oriented connection association where a device starts action is employed. In a WUSB system, a host includes identification information of each device (which is device identification information and hereinafter also referred as a device ID) belonging to its own cluster besides its own identification information (which is host identification information and hereinafter also referred as a host ID). A device includes the host ID of the host of the cluster that the device belongs besides its own device ID. At a state being ready to receive a connection request, the host notifies to the device in the cluster by transmitting a MMC including the host ID or the like at a predetermined time interval. The MMC also includes DNTS (Device Notification Time Slot), which is specified by the host that the device is able to issue a connection request to the host. The DNTS is a slot prepared for individual devices to transmit a small asynchronous notification message to a host. There are several DNTSs prepared. Incidentally, the MMC is transmitted in a broadcast format where a device to receive is not specified.

A device trying to connect with the host searches for the MMC transmitted from the host. When finding the MMC, which is when receiving the MMC, the host ID included in the MMC is compared with the host ID held by the device to check whether or not they match. If they do not match, the device determines that it is not the host of the cluster the device belongs and searches for another MMC. On the other hand, if they match, the device randomly selects a slot transmitted from the slot specified to the MMC and transmits a connection request packet including its own device ID to the host.

The host receives the connection request packet and checks whether or not the device ID therein is included in the device ID held by the host, that is, checks whether or not the device belongs to the cluster of the host. If the device that has transmitted the connection request packet belongs to the cluster of the host, the host adds to the MMC information indicating that the connection request from the device having the device ID has been accepted and transmits the MMC.

On the other hand, if the check results to fail, the host rejects the connection request by doing nothing.

The device receives the MMC from the host indicating that its connection request has been accepted and recognizes that the connection request is accepted and the device is connected with the host.

Such connection mode is used in the wireless USB hub system disclosed in Japanese Unexamined Patent Application Publication No. 2001-156797.

By the way, conventionally a connection from a device to a host is started by a user instruction (for example by pressing a button switch provided to the device). FIG. 12 is a flowchart of a flow in which a device carries out a connection process when a host and the devices are disconnected.

As shown in FIG. 12, when the host and device are disconnected, the device remains to be disconnected until a connection instruction is made by a user (S15:NO and S10). By a connection instruction from a user (S15:YES), the device searches for a host of a cluster that the device belongs (S20) The search is carried out by receiving a MMC transmitted from the host. If the host of a cluster that the device belongs is not found, the device remains to be disconnected till next connection request (S25:NO and S10). On the other hand, if the host is found, the device carries out a connection process including issuing a connection request to the host (S25:YES and S30).

It has now been discovered that in this way, a user is required to recognize whether a device is connected with a host when using the system and it is not convenient. Further, if the device is not placed within a usage range, the device cannot be connected even by a connection instruction from a user and this causes to stress the user. Moreover, as for a mobile host such as laptop computer, the host cannot be connected with a device only by a user bringing the host to the usage range and the user is required to press a switch provided to the device. This is especially inconvenient when the device and host are placed with a certain distance therebetween.

Such problem is not limited to WUSB systems but common to systems constituted of a host and device and employing device-oriented connection association where a device starts action as for connections.

### SUMMARY

According to an aspect of the present invention, there is provided a device connected wireless with a host to be used comprising a host identification information holding unit to hold identification information of the host and a connection processing unit to search for an identification signal including the host identification information transmitted from the host, the search being for connecting with the host.

Incidentally, the above device replaced with a method, system or program is effective as an aspect of the present invention.

According to the techniques of the present invention, it is possible to provide a convenience in connecting a device to a host, where the device is connected wirelessly with the host.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a block diagram showing the configuration of a WUSB system according to a first embodiment of the present invention;

FIG. 2 is a block diagram showing the configuration of a device in the WUSB system of FIG. 1;

FIG. 3 explains a data communication between the host and devices;

FIGS. 4A to 4C explain another data communication between the host and devices;

FIG. 5 is a block diagram showing the configuration of a connection processing unit in the device of FIG. 2;

FIG. 6 is a flowchart of processes by a connection controlling unit in the connection processing unit of FIG. 5;

FIG. 7 is a block diagram of the configuration of a WUSB system according to a second embodiment of the present invention;

FIG. 8 is a block diagram showing another connection mode of the WUSB system of FIG. 7;

FIG. 9 is a block diagram showing the configuration of a device in the WUSB system of FIG. 7;

FIG. 10 is a block diagram showing the configuration of the host in the WUSB system of FIG. 7;

FIG. 11 is a flowchart of processes by the host in the WUSB system of FIG. 7; and

FIG. 12 is a flowchart of a conventional method for connecting from a device to host.

### DETAILED DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposes.

### First Embodiment

FIG. 1 shows the configuration of a WUSB system 10 according to a first embodiment of the present invention. The WUSB system 10 includes one host 50 and a plurality of devices 100. Note that the number of the devices 100 is not limited to the one shown in the drawing. Further, the connection relationship in FIG. 1 between the host 50 and devices 100 is a logical bus topology and not a physical connection relationship. For example, the connection mode between the host 50 and devices 100 is wireless connection. The host 50 may be directly connected with the devices 100 or through WUSB hub.

The WUSB system 10 is one cluster and the host 50 provides a unique address (device ID) to each of the devices 100 at a formation of the cluster. The host 50 holds the device IDs for the devices 100 for later connections and data transmission after a connection is established. Further, each of the devices 100 obtains identification information (host ID) of the host 50 at the formation of the cluster and holds the identification information.

The WUSB system 10 is typically a PC having hardware functioning as a physical layer conforming to the WUSB standard and driver software for the hardware functioning as a higher-level layer of the WUSB communication protocol.

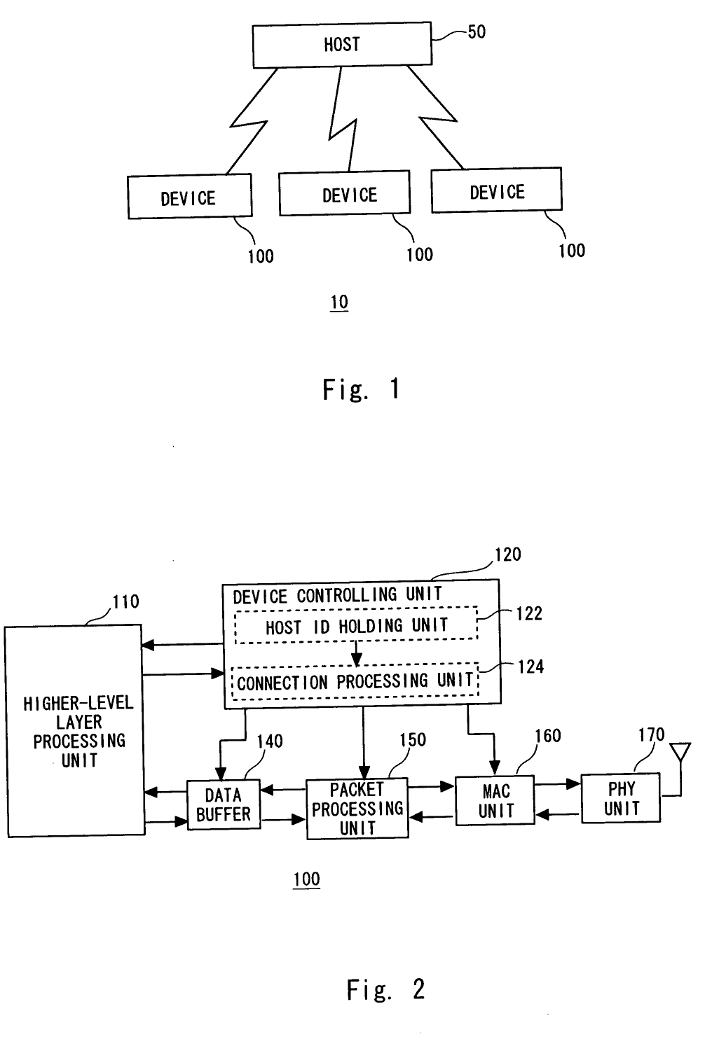

FIG. 2 shows the configuration of the device 100. The device 100 includes a higher-level layer processing unit 110, device controlling unit 120, data buffer 140, packet processing unit 150, MAC (Media Access Control) unit 160 and PHY unit 170. The higher-level layer processing unit 110 functions as a higher-level layer of the WUSB communication protocol and corresponds to a printer, external storage unit including HDD and DVD drive, and peripheral devices for a PC including a display and communication modem. The device controlling unit 120, data buffer 140, packet processing unit 150, MAC unit 160 and PHY unit 170 constitute a physical layer functioning to connect with the host 10 and transfer WUSB packets.

The data buffer 140 is a buffer memory used for saving outgoing data obtained from the higher-level layer processing unit 110 and incoming data received from the host 10. The packet processing unit 150 assembles outgoing packets and disassembles incoming packets. The MAC unit 160 is a processing unit for transmitting WUSB packets and adding a MAC header including a MAC address of the host 10 to an outgoing packet generated by the packet processing unit 150 and then outputting to the PHY unit 170. Conversely, the MAC unit 160 removes the MAC header from the data input from the PHY unit 170 and outputs WUSB packets to the packet processing unit 150. The PHY unit 170 is a processing unit for data transmission wirelessly that transmits outgoing data input from the MAC unit 160 to the host 10 and outputs data received from the host 10 to the MAC unit 160. Incidentally, to the MAC unit 160 and PHY unit 170, wireless communication technology conforming to wireless LAN standard such as IEEE 802.11 and wireless PAN (Personal Area Network) standard such as IEEE 802.15.1, IEEE 802.15.3, IEEE 802.15.4 and IEEE 802.15.3a may be applied.

The device controlling unit 120 controls the data buffer 140, packet processing unit 150, MAC unit 160 and PHY unit 170 according to a data transmission request by the higher-level layer processing unit 110. Further, the device controlling unit 120 includes a host ID holding unit 122 for holding an ID of the host 50 and its own device ID and a connection processing unit 124 for connecting from the device 100 to the host 50.

The devices 100 are able to communicate with the host 50 while being connected with the host 50. The connection between the devices 100 and host 50 is made by the connection processing unit 124 in the device controlling unit 120. Communications between the host 50 and devices 100 while the devices 100 are connected with the host 50 by the connection processing unit 124 are described hereinafter. Details of the connection processing unit 124 are described later.

In communications between a host and device in the WUSB standard, the host takes charge and a communication between the host and device is started by the host issuing a token packet to the device. A series of processes from issuing the token packet to completing a data transmission is performed in three steps, which are token phase, data phase and handshake phase. The series of processes is referred to as a transaction.

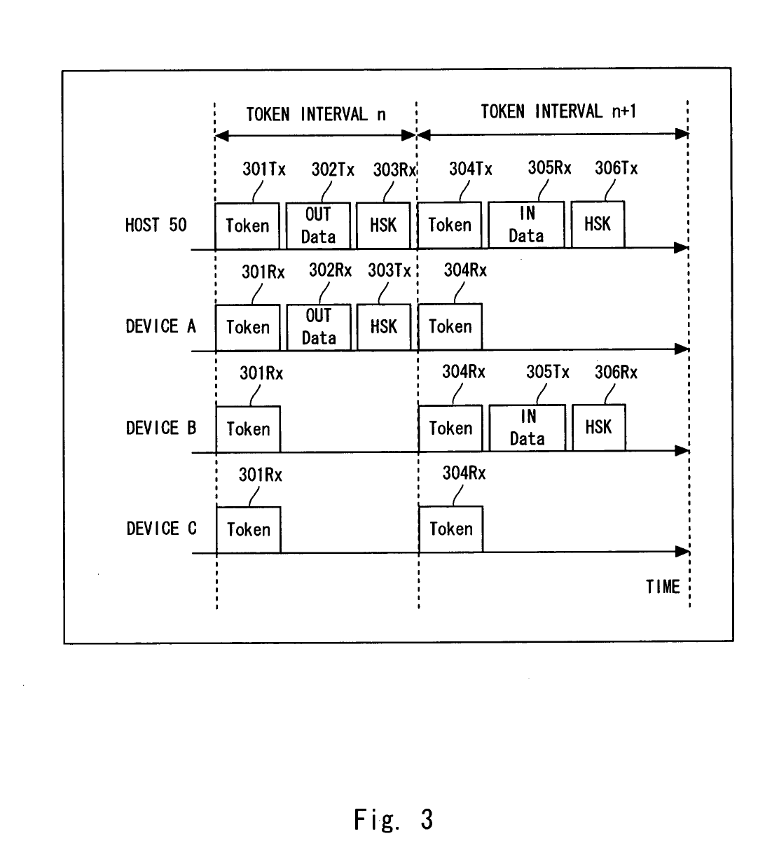

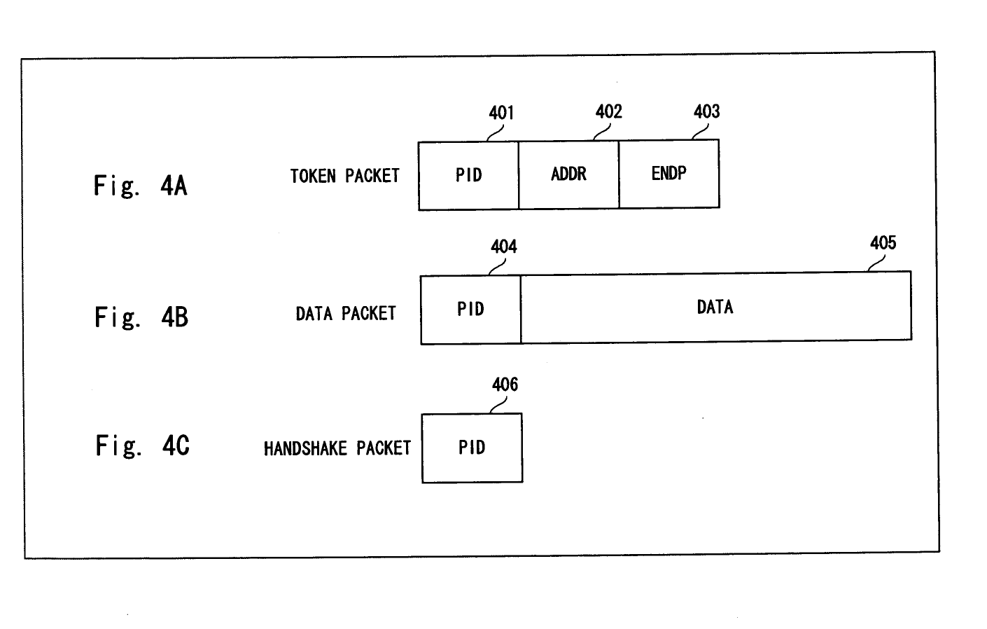

FIG. 3 is a timing chart of a data transmission between the host 50 and three devices 100 (hereinafter referred to as a device A, device B and device C for convenience) that are connected with the host 50. FIGS. 4A to 4C show the structure of a packet exchanged between the host 50 and devices 100. In FIG. 3, token intervals n and n+1 indicate transmit time interval for a token packet transmitted by the host. Each process separated by the token intervals n and n+1 corresponds to one transaction. For example the transaction for the token interval n indicates an OUT transaction where the host 50 transmits data to the device A. In the token interval n, firstly the host 50 issues a token packet 301Tx. Note that Tx and Rx indicate direction of packet to be transmitted and received, where Tx is an outgoing packet while Rx is an incoming packet. The host device 50 transmits an OUT data packet 302Tx following the OUT token packet 301Tx. One OUT transaction is completed by the device A that received an OUT 302Rx transmitting a handshake packet 303Tx to the host 50 and the host 50 receiving the handshake packet 303Tx.

Incidentally, when the OUT token packet 301Tx is issued from the host 50, all the devices A to C that are ready to receive a token packet receive a token packet 301Rx. Among the devices received the token packet 301Rx, the device A that is specified as a correspondent receives data and the devices B and C remains a state to be ready to receive a token packet (hereinafter referred to as waiting state) and wait in preparation for a next token issue.

Here, the OUT token packet 301Tx is a token packet indicating to start an OUT transaction from the host 50 to the devices. The structure of a token packet is shown in FIG. 4A. For an OUT token packet 301, a PID value indicating of an OUT transaction is specified to PID 401 and the device A, which is a correspondent device, is specified by the address (ADDR) 402 and end point (ENDP) 403. The ADDR is the device ID of the device A. Further, as shown in FIG. 4B, an OUT data packet 302 is constituted of PID 404 indicating a type of data packet and a data unit 405. As shown in FIG. 4C, a handshake packet 303 is constituted of PID 406, in which a PID value indicating a success or failure of a data reception is specified.

On the other hand, the transaction for the token interval n+1 shown in FIG. 3 indicates an IN transaction where the host 50 receives data from the devices. As for an IN transaction also, the host 50 issues a token packet 304Tx to specify a device to allow a data transmission. The device B that is specified by the token packet 304 transmits an IN data packet 305Tx to the host 50. The host 50 when succeeded to receive the IN data packet 304Rx, returns a handshake packet 306Tx to finish the IN transaction.

As set forth above, a data transmission between the host and devices in the WUSB standard is started by the host issuing a token packet including a specification of a device to be a correspondent, and the device that is in the waiting state receives a token packet issued by the USB host at every breakpoint of a transaction and interprets the token packet to find out the token packet specifies the device, the device carries out a transaction of data with the host. Otherwise, the device remains to be in the waiting state.

In such communication, processes on the side of devices are carried out by the device controlling unit 120 controlling the data buffer 140, packet processing unit 150, MAC unit 160 and PHY unit 170. The device controlling unit 120 checks the device ID included in the token packet 301 or 304 with the device ID held in the host ID holding unit 122 so as to determine whether the device is the one specified.

As set forth above, in a WUSB system, for communications between a host and device, the host takes charge and the device that is in the waiting state receives a token packet from the host so as to determine whether or not the device is the one specified.

The device 100, when a connection with the host 50 is established, enters the waiting state and is ready to receive a token packet from the host 50. Incidentally, the device 100 is in “waiting state” means specifically that the PHY unit 170, MAC unit 160 and packet processing unit 150 are ready to receive.

As described above, in a WUSB system, for communications between a host and device, the device takes charge. In the WUSB system 10 of this embodiment, a connection with the host 50 is carried out by the connection processing unit 124 in the device controlling unit 120 of the device 100.

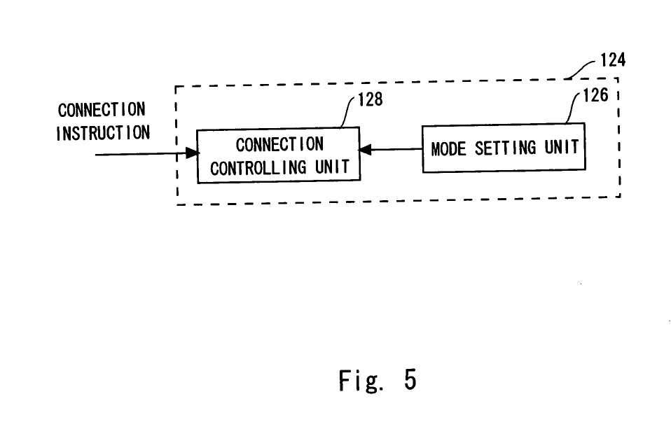

FIG. 5 shows the configuration of the connection processing unit 124. The connection processing unit 124 includes a mode setting unit 126 and a connection control unit 128. In the WUSB system 10 of this embodiment, the device 100 supports both automatic mode for automatic connection and manual mode for manual connection. The mode setting unit 126 lets a user specify either of the modes. The mode setting unit 126 may be a setting button provided to the device 100. Needless to say that it may be a firmware implemented to be specified by terminal software etc. or a user interface therefor.

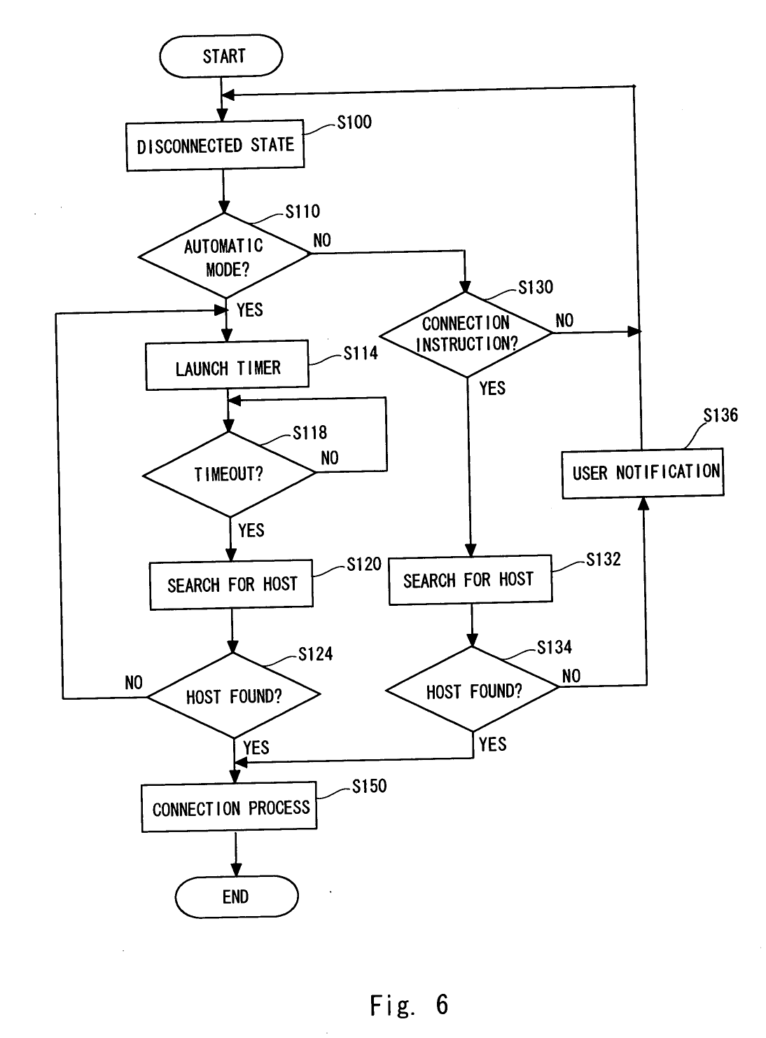

The connection controlling unit 128 controls connections according to the mode specified by the mode setting unit 126. FIG. 6 is a flowchart showing a process flow of the connection controlling unit 128.

As shown in FIG. 6, in a state where the host 50 and devices 100 are disconnected, that is the PHY unit 170, MAC unit 160, packet processing unit 150 in the device 100 are not ready to receive (S100), the connection controlling unit 128 controls connections according to the mode specified by the mode setting unit 126. Specifically, when configured to the automatic mode (S110:YES), a timer (not shown) is launched (S114). Further, when reaching a predetermined time (S118:YES), a search for the host 50 is carried out (S120). The search is performed by making the PHY unit 170, MAC unit 160, packet processing unit 150 be ready to receive and receiving a MMC from the host 50. In the MMC transmitted from the host 50, a host ID of the host 50 is included. The connection controlling unit 128 checks a host ID included in the received MMC with a host ID held in the host ID holding unit 122 and when they match, the connection controlling unit 128 determines that the host is a host of a cluster that the host belongs and starts a connection (S124:YES and S150). The connection is started by transmitting a packet requesting the connection from the packet processing unit 150, MAC unit 160 and PHY unit 170 and then established through mutual authentification by a handshake between the host 50 and device 100. This makes the device 100 to be in waiting state and enables a communication with the host 50.

Further, in step S124, if the MMC is not received or received but the host ID included therein is not the host ID of the cluster that the host belongs (S124:NO), the connection controlling unit 128 returns the PHY unit 170, MAC unit 160 and packet processing unit 150 to dormant state and then repeats the processes from step S114.

On the other hand, in step S110, when the mode is configured to the automatic mode (S110:NO), the connection controlling unit 128 remains to be disconnected until a connection instruction is made from a user (S130:NO). The connection instruction from the user may be a press of a button switch provided to the device 100, for example, but not limited to this.

In step S120, when a connection instruction is made from a user (S130:YES), the connection controlling unit 128 searches for the host 50 (S132). The search in step S132 is identical to the process in step S120, thus the explanation will not be repeated here.

When the host 50 is found, the connection controlling unit 128 starts a connection (S134:YES and S150). On the other hand, if the host 50 is not found, a notification indicating that “host is not found” is sent to the user (S136) and the process returns to the disconnected state of step S100. Note that the notification in step S136 maybe any form as long as the information is notified to a user such as a LED blink and voice announcement.

As set forth above, according to the WUSB system 10 of this embodiment, the connection processing unit 124 launches the timer in the disconnected state when configured to the automatic mode and searches for the host 50 at a timeout. Then, while starting a connection when finding the host 50, if the host 50 is not found, the timer is launched again and the host is searched at a timeout. By this, in the WUSB system, the device is able to connect without an instruction from a user if the host of the cluster that the device belongs exists in the usage range and it is convenient for the user.

In the WUSB system 10 of this embodiment, the connection processing unit 124 is able to specify two modes which are the automatic and manual mode and carries out a connection operation according to the specified mode. According to this, when a user attempts to reduce power consumption for example, by configuring to the manual mode, the device 100 remains to be disconnected until an instruction is made from the user. That is, a user-oriented system is accomplished that provides a selection according to the situation while providing convenience to users.

Further, the connection processing unit 124 in the device 100 searches for a host or connects at a predetermined time interval and not continuously when configured to the automatic mode. Thus the power consumption can be reduced.

### Second Embodiment

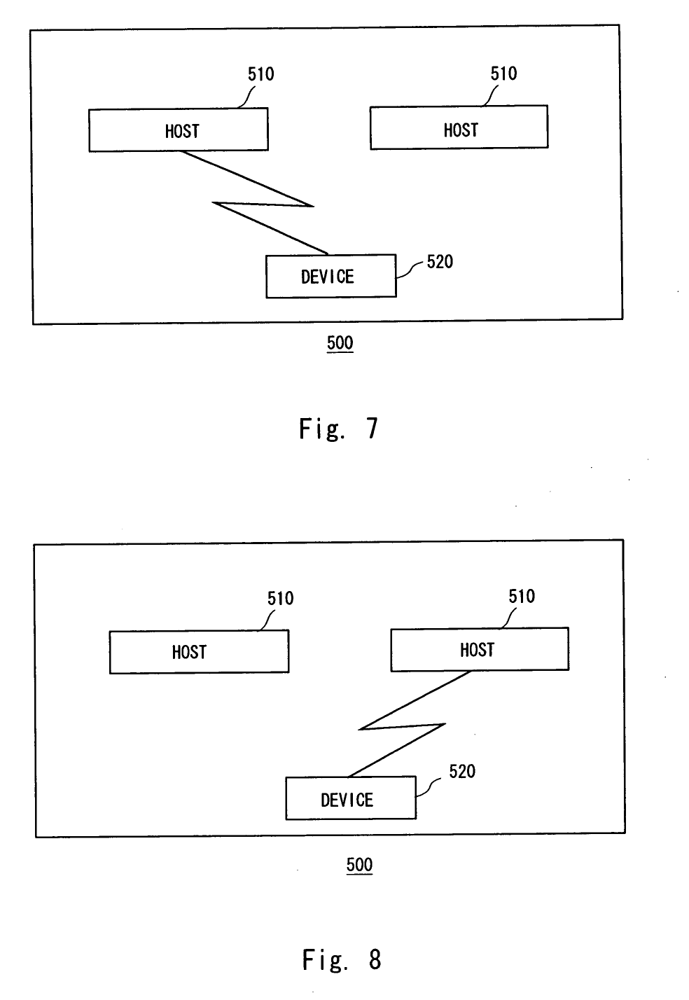

FIG. 7 shows the configuration of a WUSB system 500 according to a second embodiment of the present invention. The WUSB system 500 includes hosts 510 and a device 520. For the convenience of explanation, two hosts 510 and one device 520 are shown in FIG. 7, however the number of hosts and devices is not limited to the drawing. Further, as with the explanation for the WUSB system 10 of the first embodiment, the connection relationship in FIG. 7 between the hosts 510 and device 520 is a logical bus topology and not a physical connection relationship.

The WUSB system 500 is an example in which a plurality of host devices 510, two in this example, shares the device 520. The device 520 connects with either of the host 510. In the example shown in FIG. 7, the device 520 is connected with the left host 510, however it may be connected with the right host 510 as shown in FIG. 8.

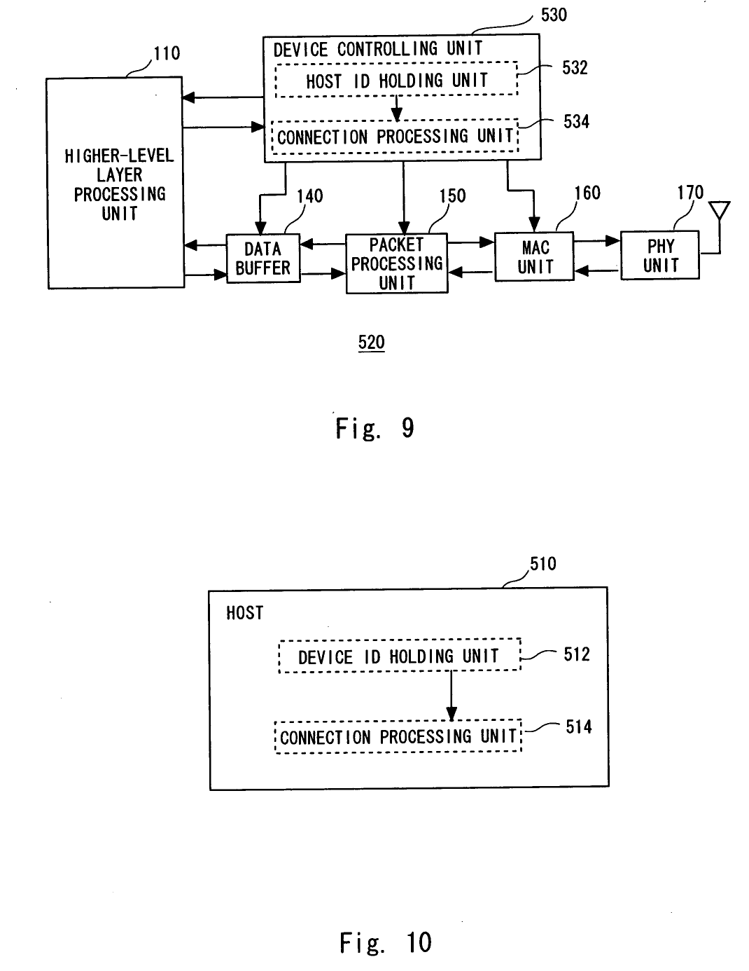

FIG. 9 shows the configuration of the device 520. Excluding a device controlling unit 530, the device 520 is identical to the corresponding functional blocks in the device 100 (see FIG. 2) in the WUSB system 10. In FIG. 9, components identical to those in FIG. 3 are denoted by reference numerals identical to those therein with detailed description omitted.

The device controlling unit 530 in the device 520 includes a host ID holding unit 532 and a connection processing unit 534. The host ID holding unit 532 holds its own device ID and host IDs of the two hosts 510. The connection processing unit 534 connects from the device 520 to either of the hosts 510.

As with the connection processing unit 124 in the device 100 shown in FIG. 2, the connection processing unit 534 also supports both the automatic mode for automatic connection and manual mode for manual connection. When configured to the manual mode, no connection process is carried out until a connection instruction is made by a user. When configured to the automatic mode, a search for the two hosts 510 are performed at predetermined time interval. The connection processing unit 534 when succeeded to find either of the host 510, that is when a MMC including either of the host IDs held in the host ID holding unit 532 is received, starts a connection with the host 510 having corresponding host ID and transmits a packet requesting for a connection to the corresponding host 510.

If the host 510 did not allow the connection request, the connection processing unit 534 continues connection request in a predetermined length of period until a connection is allowed by the corresponding host. If the period has passed without allowing for a connection, the connection processing unit 534 stops the connection request to the corresponding host and search for another host 510 that is held by the host ID holding unit 530 so as to connect after succeeding the search for the host.

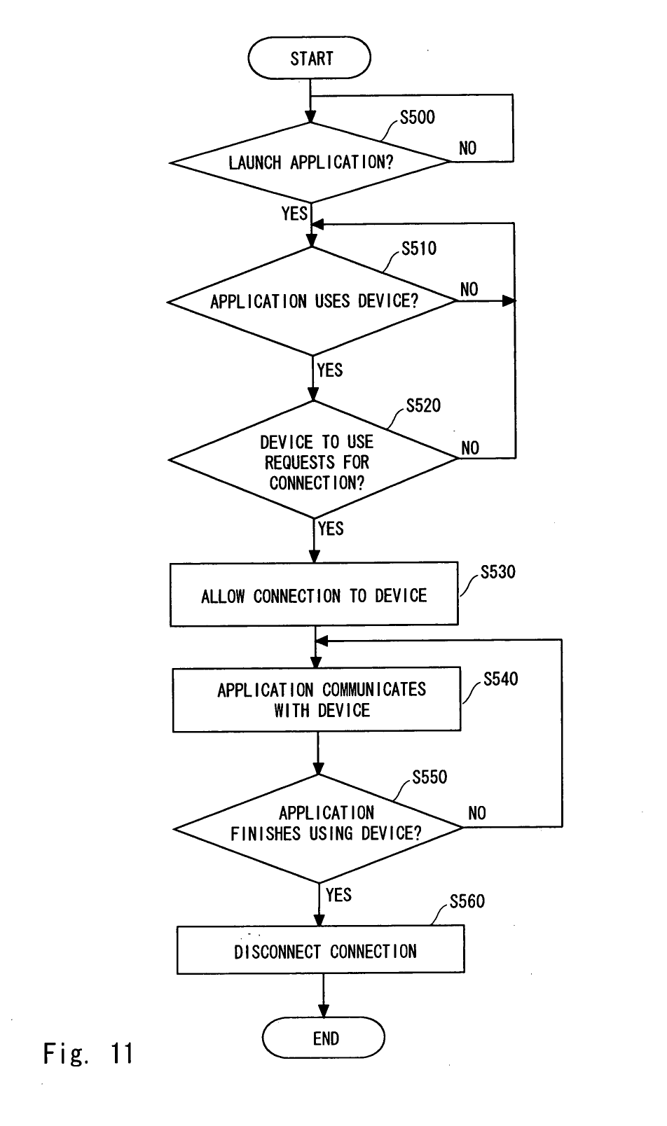

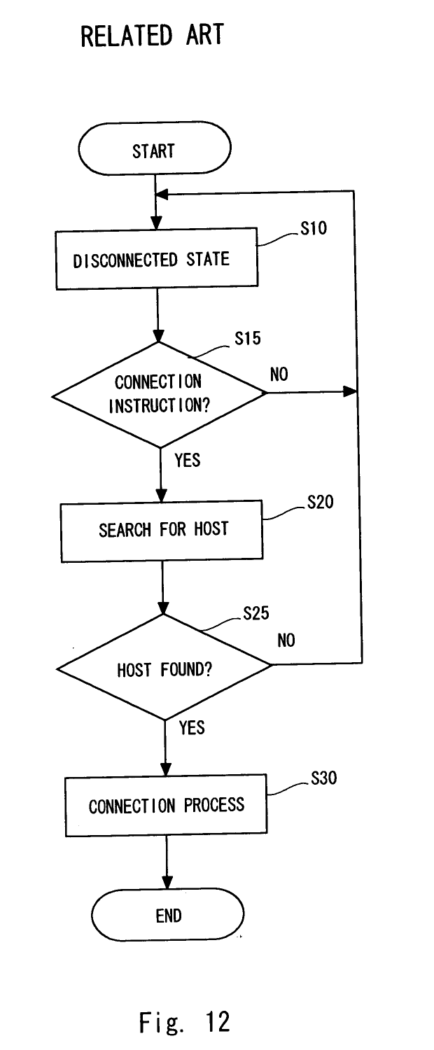

FIG. 10 shows the configuration of the host 510. For the host 510, only the components concerning the principle of the present invention are drawn and explained and other components included in the normal host 510 are omitted.

As shown in FIG. 10, the host 510 includes a device ID holding unit 512 a connection processing unit 514. The device ID holding unit 512 holds a device ID of a device in the same cluster. In the example of WUSB system 500, the device ID of the device 520 is held by the device ID holding unit 512 of the two hosts 510.

The connection processing unit 514 in the host 510 allows a connection for only the device requested to be used by implemented application software (hereinafter simply referred to as an application). Evaluation of whether or not the application is requesting to use the device may be various design aspect, for example launching the application may be a usage request for a predetermined device or only a usage request from an operating application may be a usage request for a targeted device. In this embodiment, the connection processing unit 514 takes only a usage request from an operating application as a usage request for the targeted device.

FIG. 11 is a flowchart showing a process flow of the connection processing unit 514. After an application is launched, the connection processing unit 514 checks whether the application issues a usage request for the device 520 (S500:YES and S510). Until the application requests to use the device 520, the device processing unit 514 will not allow a connection even with a connection request from the device 520.

When an application issues a usage request for the device 520 (S520:YES), the connection processing unit 514 checks whether or not a connection request from the device 520 exists (S520). If there is no connection request from the device 520, no connection is carried out and the process is returned to step S510. If there is a connection request, a connection process is allowed to connect (S530). After that, a communication between the application and device 520 is carried out (S540). When the application finishes to use the device 520 (S550:YES), the connection processing unit 514 disconnects the connection with the device 520 (S560).

As set forth above, according to the WUSB system 500 of this embodiment, the device 520, when configured to the automatic mode, searches for the host 510 at a predetermined time interval and requests for a connection with the host 510 that was found. If the request is not allowed, request for the connection is continued within a predetermined length of period. However when the connection is not allowed after the predetermined period, the connection request for the host is stopped and another host is searched and connected. The host 510 allows a connection request only from a device that an application is requesting to use. When the application finishes to use the corresponding device, the connection with the device is disconnected. By such configuration, several hosts are able to use the device 520 in a time sharing manner, thus a device can be shared by hosts.

In the WUSB system 500 of this embodiment shown in FIG. 7, the hosts share one device 520 as an example. However it is needless to say that several hosts can share several devices by the techniques of the present invention.

Having thus described the present invention by reference to certain of its preferred embodiments, it is noted that the embodiments disclosed are illustrative and that a wide range of variations, modifications, changes, and substitutions are contemplated in the foregoing disclosure. Many such variations and modifications may be considered desirable by those skilled in the art based upon a review of the foregoing description of preferred embodiments.

For example in the WUSB system 10 of this embodiment, the connection processing unit 124 in the device 100 supports two modes. However the device 100 may be configured to perform only the operations when configured to the automatic mode.

Further in the WUSB system 10, a user is notified of not finding a host only in the manual mode, however it may be done in the same way as for the automatic mode.

Furthermore, although this embodiment is the WUSB system incorporating the present invention, the techniques of the present invention may be incorporated to any system constituted of a host and device and employing device-oriented connection association where a device starts action, as for connections.

The components illustrated in the drawings as functional blocks for performing various processes of the WUSB system 10 and WUSB system 500 may be configured by a processor, memory and other LSI for hardware. For software, they may be achieved by programs loaded to a memory or the like. Thus those skilled in the art will recognize that the functional blocks can be accomplished only by hardware, software or combination thereof and it is not limited to any one of them.

It is apparent that the present invention is not limited to the above embodiments, but may be modified and changed without departing from the scope and spirit of the invention.

What is claimed is:

1. A device connected wireless with a host to be used comprising:
a host identification information holding unit to hold identification information of the host; and
a connection processing unit to search for an identification signal including the host identification information transmitted from the host, the search being for connecting with the host.

2. The device according to claim 1, wherein the connection processing unit performs the search at a predetermined time interval.

3. The device according to claim 1, wherein the host is a wireless USB (WUSB: Wireless Universal Serial Bus) host, and
the connection processing unit performs a search for a MMC (Micro-scheduled Management Command) from the wireless USB host.

4. The device according to claim 2, wherein the host is a wireless USB (WUSB: Wireless Universal Serial Bus) host, and
the connection processing unit performs a search for a MMC (Micro-scheduled Management Command) from the wireless USB host.

5. The device according to claim 1, further comprising a mode setting unit enabling to specify a manual mode and automatic mode,
wherein the connection processing unit performs the search only by an instruction for the search in case of being configured to the manual mode, and
the search is performed intermittently until the search is succeeded in case of being configured to the automatic mode.

6. The device according to claim 2, further comprising a mode setting unit to enable specifying a manual mode and an automatic mode,
wherein the connection processing unit performs the search only by an instruction for the search in case of being configured to the manual mode, and
the search is performed intermittently until the search is succeeded in case of being configured to the automatic mode.

7. The device according to claim 1, wherein the connection processing unit, after succeeding the search, continues requesting for a connection within a predetermined length of period until a connection is allowed by the host.

8. The device according to claim 7, wherein the host identification holding unit holds identification information of a plurality of the hosts, and
the connection processing unit, after succeeding the search for one of the plurality of the hosts, in case a connection is not allowed by the host in the predetermined length of time, a connection request for the host is stopped and the search is performed for another host among the plurality of the hosts, identification information of the plurality of hosts being held by the host identification information holding unit.

9. A method to control connections for a device connected wirelessly with a host to be used, comprising:
performing intermittently a search for an identification signal including identification information to identify a host transmitted from the host until the search is succeeded, the search being for connecting with the device.

10. The method according to claim 9, wherein the search is performed at a predetermined time interval.

11. The device according to claim 9, wherein the host is a wireless USB (WUSB: Wireless Universal Serial Bus) host, and
the search is for a MMC (Micro-scheduled Management Command) from the wireless USB host.

12. The device according to claim 10, wherein the host is a wireless USB (WUSB: Wireless Universal Serial Bus) host, and
the search is for a MMC (Micro-scheduled Management Command) from the wireless USB host.

13. The method according to claim 9, wherein a manual and automatic mode can be specified,
the search is performed only by an instruction for a search in case of being configured to the manual mode, and
the search is performed intermittently until the search is succeeded in case of being configured to the automatic mode.

14. The method according to claim 10, wherein a manual and automatic mode can be specified,
the search is performed only by an instruction for a search in case of being configured to the manual mode, and
the search is performed intermittently until the search is succeeded in case of being configured to the automatic mode.

15. The method according to claim 9, wherein after the search is succeeded, a request for connection is continued until a connection is allowed by the host.

16. The method according to claim 10, wherein after the search is succeeded, a request for connection is continued until a connection is allowed by the host.

17. The method according to claim 15, further comprising:
holding identification information of a plurality of the hosts, wherein after the search is succeeded for one of the plurality of the hosts, in case a connection is not allowed by the host within the predetermined length of period, a connection request for the host is stopped and the search is performed for another host among the plurality of the hosts.

18. A host connected with a device to be used, comprising:
a connection processing unit to allow for a connection with a device requesting for a connection under a condition application software implemented to the device is requesting to use the device.

19. The host according to claim 18, wherein the connection processing unit, after allowing for a connection, at an end of the usage of the device by the application software, disconnects the device.

20. The host according to claim 19, wherein the connection processing unit connects or disconnects with the device according to a usage request or a disconnection request for the device issued from the application software.
